(19) United States
(12) Patent Application Publication
(10) Pub. No.: US 2025/0277502 A1
(43) Pub. Date: Sep. 4, 2025

(54) Fastening Clip and Fastening Clip Assembly Comprising Same

(71) Applicant: Illinois Tool Works Inc., Glenview, IL (US)

(72) Inventors: Zheng Luo, Shanghai (CN); Jiahui He, Shanghai (CN)

(21) Appl. No.: 19/068,452

(22) Filed: Mar. 3, 2025

(30) Foreign Application Priority Data
Mar. 4, 2024 (CN) 202410241795.9
Feb. 21, 2025 (CN) 202510196060.3

(51) Int. Cl. F16B 21/07

(52) U.S. Cl. CPC F16B 21/073

(57) ABSTRACT

The present disclosure provides a fastening clip including a first connecter and a second connecter releasably connected to each other. When the fastening clip connects two components, the first connecter and the second connecter are firmly connected to the two components, respectively. Moreover, the two components are separated from each other by releasing the first connecter and the second connecter of the fastening clip of the present disclosure, so that it is possible to avoid wear between the components made of a metal material and the fastening clip made of a plastic material. The fastening clip is particularly suitable for mounting two components with at least one being made of a metal material.

### RELATED APPLICATIONS

The present application claims priority to the Chinese Patent Application Nos. 202410241795.9, filed Mar. 4, 2024, and 202510196060.3, filed Feb. 21, 2025, each titled “Fastening Clip and Fastening Clip Assembly Comprising Same,” the contents of which are hereby incorporated by reference.

### BACKGROUND

In recent years, fastening clips have been developed for fastening a plurality of components to each other. For example, a vehicle includes various components (e.g., metal components or plastic components) that are connected to each other to form a vehicle body, a vehicle door and an interior trim of the vehicle. Some existing fastening clips are usually made of a plastic material. When such existing fastening clips are used to connect two components made of a metal material to each other, it is usually necessary to form holes in the components made of the metal material so as to allow the fastening clip to be inserted into the holes to secure the components and then to connect the two components to each other.

### SUMMARY

The present disclosure relates generally to a fastening clip, substantially as illustrated by and described in connection with at least one of the figures, as set forth more completely in the claims. In one example, the present disclosure relates to a fastening clip, and more particularly to a fastening clip for firmly connecting a plurality of automotive parts together and a fastening clip assembly including the fastening clip.

### DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastening clip at one angle according to one embodiment of the present disclosure.

FIG. 1B is an exploded perspective view of the fastening clip shown in FIG. 1A at another angle.

FIG. 1C is a top view of the fastening clip shown in FIG. 1A.

FIG. 1D is a front view of the fastening clip shown in FIG. 1A.

FIG. 2A is a cross-sectional view of the fastening clip shown in FIG. 1C along line A-A.

FIG. 2B is a cross-sectional view of the fastening clip shown in FIG. 1D along line B-B.

FIG. 3A is a perspective view of a first connecter in FIG. 1A.

FIG. 3B is a top view of the first connecter shown in FIG. 3A.

FIG. 3C is a cross-sectional view of the first connecter shown in FIG. 3B along line C-C.

FIG. 3D is a cross-sectional view of the first connecter shown in FIG. 3B along line D-D.

FIG. 4A is a perspective view of a second connecter in FIG. 1A.

FIG. 4B is a top view of the second connecter shown in FIG. 4A.

FIG. 5A is a perspective view of a fastening clip assembly including the fastening clip shown in FIG. 1A in an assembled state.

FIG. 5B is a cross-sectional view of the fastening clip assembly shown in FIG. 5A.

FIG. 6A is a perspective view of the fastening clip assembly including the fastening clip shown in FIG. 1A in a disassembled state.

FIG. 6B is a cross-sectional view of the fastening clip assembly shown in FIG. 6A.

FIG. 7A is a perspective view of a fastening clip according to another embodiment of the present disclosure at an angle.

FIG. 7B is an exploded perspective view of the fastening clip shown in FIG. 7A at another angle.

FIG. 7C is a top view of the fastening clip shown in FIG. 7A.

FIG. 7D is a front view of the fastening clip shown in FIG. 7A.

FIG. 7E is a cross-sectional view of the fastening clip shown in FIG. 7C along line E-E.

FIG. 8A is a perspective view of a first connecter in FIG. 7A.

FIG. 8B is a cross-sectional view of the first connecter shown in FIG. 7C along line E-E.

FIG. 9A is a perspective view of a second connecter in FIG. 7A.

FIG. 9B is a left side view of the second connecter in FIG. 9A.

FIG. 10A is a perspective view of a fastening clip assembly including the fastening clip shown in FIG. 7A in an assembled state.

FIG. 10B is a cross-sectional view of the fastening clip assembly shown in FIG. 10A along line F-F in FIG. 7C.

FIG. 11A is a perspective view of a fastening clip assembly including the fastening clip shown in FIG. 7A in a disassembled state.

FIG. 11B is a cross-sectional view of the fastening clip assembly shown in FIG. 11A along line F-F in FIG. 7C.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

It has been found that if it is necessary to disassemble the two components, it is usually necessary to pull out the fastening clip from the holes of the metal components. This causes the disassembly to occur between the plastic material and the metal material, which can easily result in wear of the plastic material.

In a first aspect, the present disclosure provides a fastening clip including a first connecter and a second connecter. The first connecter has an axis and a central channel extending along the axis. The first connecter is provided with a groove on an outer peripheral wall. The second connecter includes a main body portion and a sleeve portion. The main body portion is provided with a retaining cavity and at least one retaining arm. The at least one retaining arm is connected to an inner surface of the main body portion at one end and extends from the inner surface of the main body portion toward the retaining cavity. The sleeve portion is connected to the top of the main body portion and is receivable in the central channel of the first connecter. The first connecter and the second connecter are configured to be releasably connected to each other.

According to the first aspect described above, the first connecter includes at least one snap-fit spring clip. The at least one snap-fit spring clip obliquely extends, from a wall that defines the central channel, toward the central channel. The sleeve portion of the second connecter is releasably connected to the first connecter via the at least one snap-fit spring clip in a snap-fit manner.

According to the first aspect described above, each of the snap-fit spring clips has a connection end and a free end. One end of each of the snap-fit spring clips is connected to the wall that defines the central channel to form the connection end, and the other end of each of the snap-fit spring clips forms the free end. The at least one snap-fit spring clip is configured to be elastically deformable to allow the sleeve portion of the second connecter to enter the central channel and to be restorable to retain the sleeve portion in the central channel.

According to the first aspect described above, the sleeve portion includes a step portion formed protruding outwardly from an outer wall of the sleeve portion. The sleeve portion is configured such that when the at least one snap-fit spring clip is restored, the step portion abuts against the free end of the at least one snap-fit spring clip to retain the sleeve portion in the central channel.

According to the first aspect described above, the step portion has a guided surface at the top of the step portion which extends obliquely outwardly in the top-bottom direction, and/or an inclined bottom end surface at the bottom of the step portion which extends obliquely inwardly in the top-bottom direction. The guided surface is configured to cooperate with the at least one snap-fit spring clip so as to urge the at least one snap-fit spring clip to elastically deform to allow the sleeve portion of the second connecter to enter the central channel. The inclined bottom end surface is configured to cooperate with the at least one snap-fit spring clip so as to abut against the free end of the at least one snap-fit spring clip upon the snap-fit spring clip restores, to retain the sleeve portion in the central channel.

According to the first aspect described above, the step portion has a flat top end surface which has a smooth edge.

According to the first aspect described above, the first connecter includes a neck, a top flange and a bottom flange. The central channel is defined in the neck. The top flange is formed extending outwardly from the top of the neck. The bottom flange is formed extending outwardly from the bottom of the neck. The groove is defined to form on an outer side of the neck between the top flange and the bottom flange.

According to the first aspect described above, the first connecter further includes a barrel portion formed extending downwardly and flaring outwardly from the bottom of the neck. The main body portion of the second connecter includes a first main body formed extending downwardly and flaring outwardly from the bottom of the sleeve portion. The barrel portion and the first main body are matched in shape such that when the first connecter is connected to the second connecter, the first main body abuts against an inner side of the barrel portion.

According to the first aspect described above, the first connecter is configured to be mounted together with a first component. A first anti-rotation structure is provided on the first connecter and the first component. The first anti-rotation structure includes the top flange in the shape of a polygon with edges and corners.

According to the first aspect described above, a second anti-rotation structure is provided on the first connecter and the second connecter to prevent the relative rotation between the first connecter and the second connecter.

According to the first aspect described above, the second anti-rotation structure includes a first toothed portion disposed at a bottom end of the barrel portion of the first connecter, and a second toothed portion connected to an outer side of the main body portion of the second connecter. The first toothed portion and the second toothed portion mesh and cooperate with each other to prevent the relative rotation between the first connecter and the second connecter.

According to the first aspect described above, the first toothed portion and the second toothed portion are triangular teeth.

According to the first aspect described above, the first toothed portion includes a ring of teeth arranged in a circumferential direction, and the second toothed portion includes a single tooth.

According to the first aspect described above, the second connecter further includes at least one support boss disposed on the outer side of the main body portion and configured to be capable of at least partially supporting the first toothed portion of the first connecter when the first connecter is connected to the second connecter.

According to the first aspect described above, the sleeve portion includes at least one elastic leg configured to be releasably connected to the at least one snap-fit spring clip in a snap-fit manner.

According to the first aspect described above, the fastening clip is made of a plastic material.

In a second aspect, the present disclosure provides a fastening clip assembly, including a first component, a second component and a fastening clip according to the first aspect. The second component includes a body and a pin which are fixedly connected to each other. The first component is received by the groove of the first connecter, and the pin is capable of being cooperatively connected to the retaining arm of the second connecter of the fastening clip to securely connect the first component to the second component.

According to the second aspect described above, the first component includes a flat plate portion and a ring-shaped wall disposed around a peripheral edge of the flat plate portion. The flat plate portion is engaged within the groove of the first connecter. A first anti-rotation structure is provided on the first connecter and the first component. The first anti-rotation structure including the top flange in the shape of a polygon with edges and corners and a ring-shaped wall matching the shape of the top flange, to prevent the relative rotation between the first connecter and the first component.

According to the first aspect described above, one of the first component and the second component is made of a metal material and the other is made of a plastic material.

The present disclosure provides a fastening clip including a first connecter and a second connecter which are releasably connected to each other. When the fastening clip connects two components (especially for fixing vehicle parts), the first connecter and the second connecter are firmly connected to the two components, respectively. Moreover, the two components are separated from each other by disassembling the first connecter and the second connecter of the fastening clip of the present disclosure, so that it is possible to avoid wear between the components made of a metal material and the fastening clip made of a plastic material. The fastening clip of the present disclosure is particularly suitable for connecting two components with at least one being made of a metal material.

Other objectives and advantages of the present disclosure will be apparent from the following description of the present disclosure with reference to the drawings, which can contribute to a comprehensive understanding of the present disclosure.

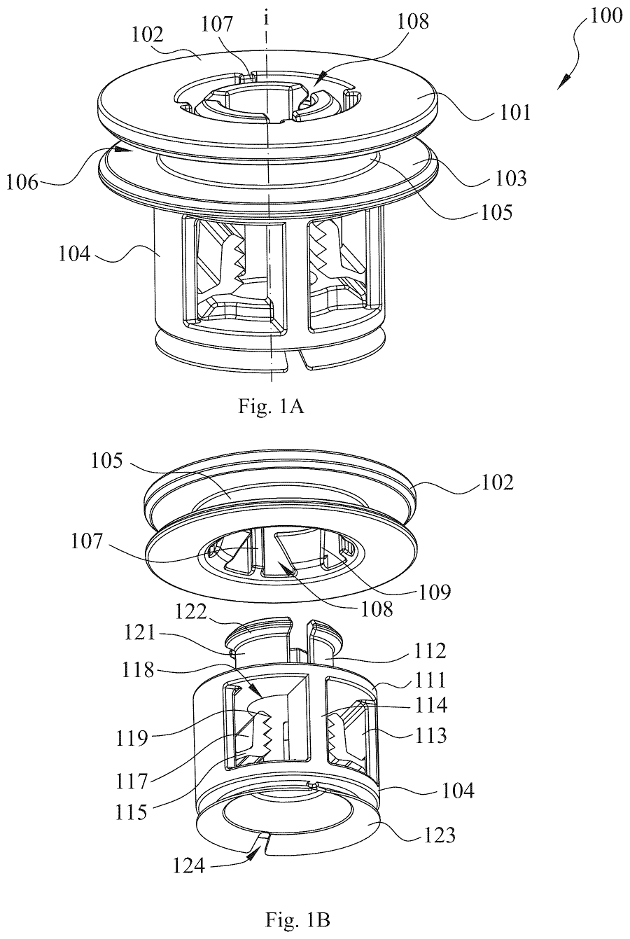

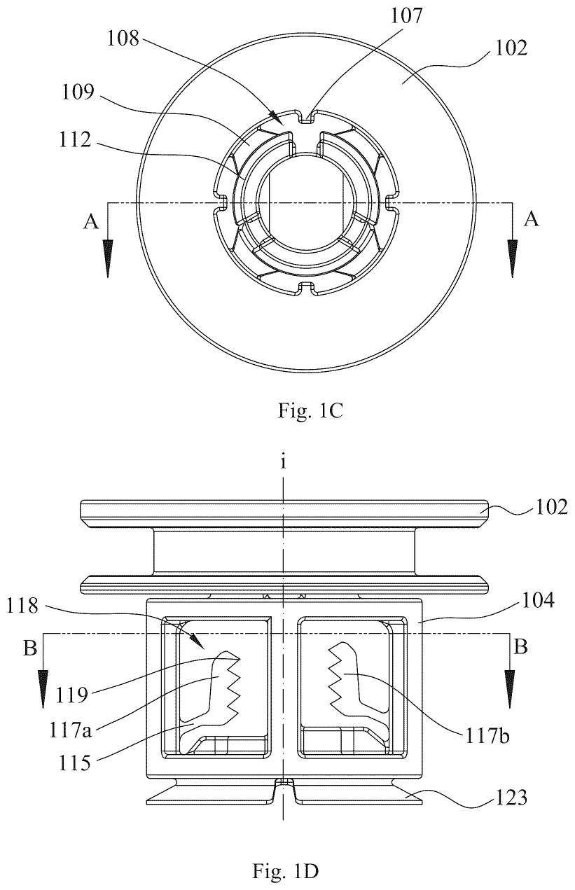

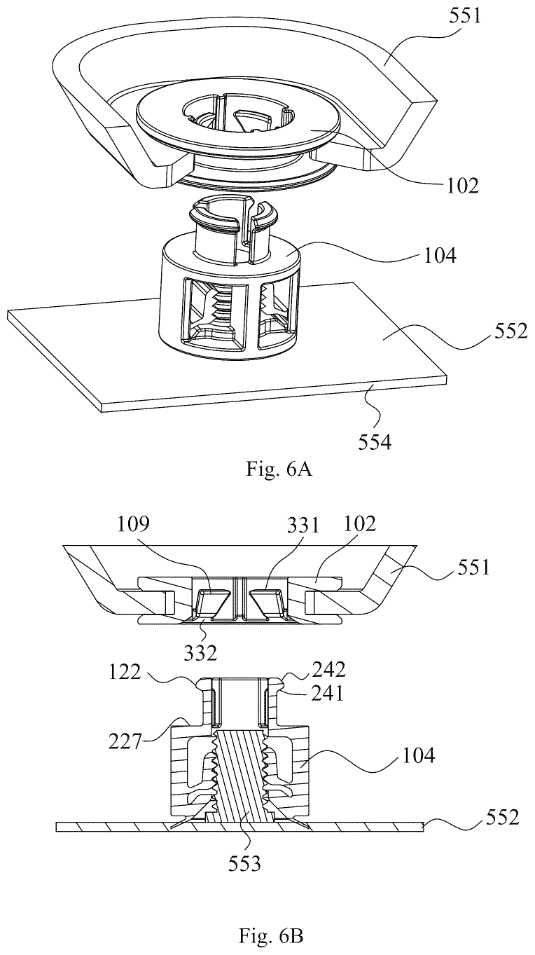

FIGS. 1A-1D show the basic structure of a fastening clip 100 according to one embodiment of the present disclosure. FIG. 1A shows a perspective view of the fastening clip 100 from a top view. FIG. 1B shows a perspective view of the fastening clip 100 from a different bottom view. FIG. 1C shows a top view of the fastening clip 100. FIG. 1D shows a front view of the fastening clip 100. As shown in FIGS. 1A-1D, the fastening clip 100 includes a first connecter 102 and a second connecter 104. The first connecter 102 and the second connecter 104 are releasably connected together. The first connecter 102 is configured to connect a first component 551 to be securely connected, and a second connecter 104 is configured to connect a second component 552 to be securely connected (see FIGS. 5A and 6A). Thus, by disassembling and assembling the first connecter 102 and the second connecter 104, the first component 551 and the second component 552 can be releasably connected together. In this embodiment, the second connecter 104 and the first connecter 102 have coaxial shapes, and the second connecter 104 is inserted axially into the first connecter 102 and releasably connected to the first connecter 102. Moreover, in this embodiment, the first connecter 102 and the second connecter 104 are releasably connected together in a snap-fit manner. It can be understood by those skilled in the art that the first connecter 102 and the second connecter 104 may be connected together in any other releasable manner.

In this embodiment, the first connecter 102 is substantially in the shape of a cylinder having an axis i. The first connecter 102 includes a neck 105 and a central channel 108. The neck 105 is in the shape of a circular ring with the central channel 108 running through the center of the neck 105. The central channel 108 extends along the axis i.

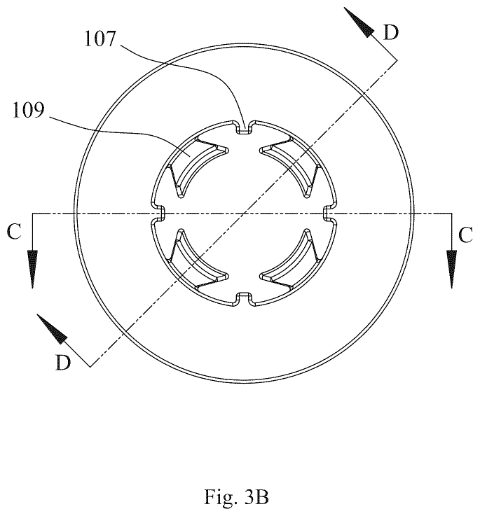

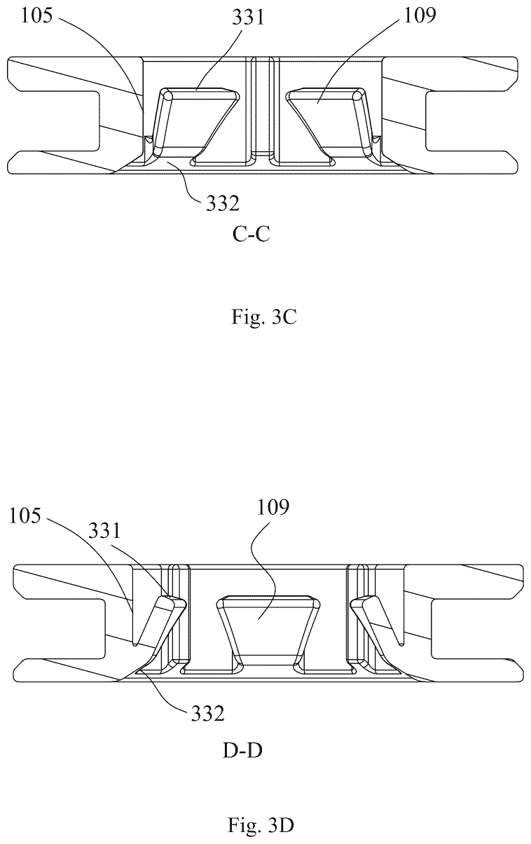

The first connecter 102 further includes at least one snap-fit spring clip 109. One end of each snap-fit spring clip 109 is connected to a wall that defines the central channel 108 to form a connection end. That is, the at least one snap-fit spring clip 109 is connected to an inner surface of the neck 105. The at least one snap-fit spring clip 109 extends obliquely into the central channel 108. The other end of each snap-fit spring clip 109 forms a free end. In this way, each snap-fit spring clip 109 have a certain elasticity, and a distance between the free end of each snap-fit spring clip 109 and the axis i is less than a distance between its connection end and the axis i. The first connecter 102 further includes at least one guide strip 107 also disposed on the wall that defines the central channel 108. Put it differently, the at least one guide strip 107 is disposed on the inner surface of the neck 105. The at least one guide strip 107 extends parallel to the axis i. In this embodiment, the first connecter 102 includes four snap-fit spring clips 109 and four guide strips 107. The four snap-fit spring clips 109 are arranged at intervals circumferentially around the axis i, and the four guide strips 107 are each disposed between two adjacent snap-fit spring clips 109. The snap-fit spring clips 109 are configured to connect the second connecter 104 in a snap-fit manner, and the central channel 108 is configured for receiving at least part of the second connecter 104. The more specific structures of the snap-fit spring clip 109 and the guide strip 107 will be described in detail with reference to FIGS. 3A-3D.

The first connecter 102 further includes a top flange 101, a bottom flange 103 and a groove 106. The top flange 101 is formed extending outwardly from the top of the neck 105, for example, extending horizontally in a radial direction. The bottom flange 103 is formed extending outwardly from the bottom of the neck 105, for example, extending horizontally in a radial direction. In this way, the first connecter 102 has the groove 106 between the top flange 101 and the bottom flange 103. The groove 106 is configured to receive a plate to be securely connected, such as a flat plate portion 555 of the first component 551 (see FIGS. 5A and 5B). In this embodiment, the groove 106 is a circular ring-shaped groove. It can be understood by those skilled in the art that the groove 106 of the first connecter 102 may also be provided as a groove in the shape of a square ring, a polygonal ring or any other shapes, to receive the first component of another shape to be securely connected. Moreover, although in this embodiment, the top flange 101 and the bottom flange 103 are circular ring-shaped flanges, in other embodiments, the top flange 101 or the bottom flange 103 may be configured to be flanges having an outer peripheral wall in the shape of a square or other polygonal shapes.

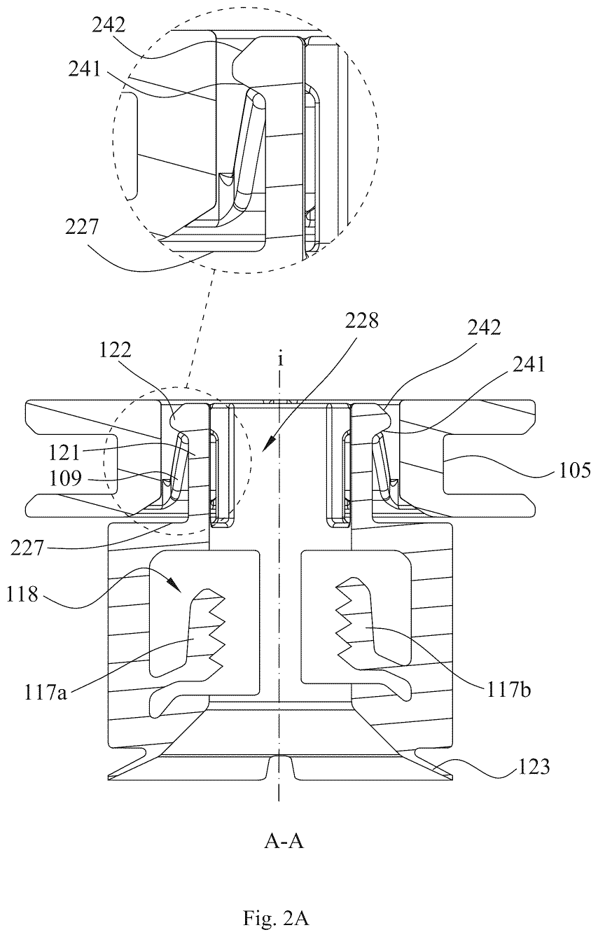

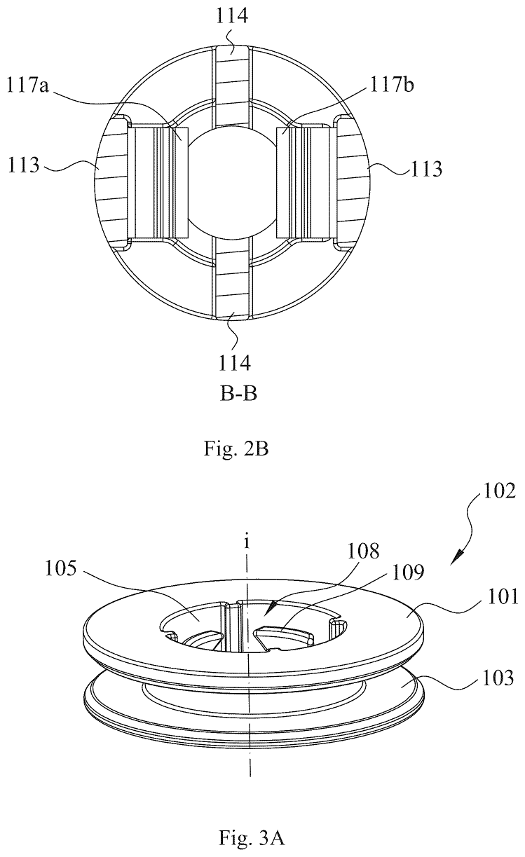

The second connecter 104 includes a main body portion 111, a sleeve portion 112 and a flared mouth portion 123 having a common axis i. The sleeve portion 112 is connected to the top of the main body portion 111, and the flared mouth portion 123 is connected to the bottom of the main body portion 111. The sleeve portion 112 is in the shape of a cylinder for insertion into the central channel 108 of the first connecter 102 and the snap-fit connection with the snap-fit spring clips 109 in the central channel 108. The top end of the sleeve portion 112 has step portions 122 protruding outwardly. The distance between the distal ends of the step portions 122 and the axis i is set to be less than the distance between the connection end of the snap-fit spring clips 109 and the axis i, but greater than the distance between the free ends of the snap-fit spring clips 109 and the axis i. When the first connecter 102 and the second connecter 104 are assembled together, the step portions 122 abut against the top ends of the snap-fit spring clips 109 of the first connecter 102 to prevent the downward movement of the second connecter 104 relative to the first connecter 102. In some embodiments, the sleeve portion 112 includes at least one elastic leg 121. The distance between an outer surface of the elastic leg 121 and the axis i is substantially equal to the distance between the free ends of the snap-fit spring clips 109 and the axis i such that when the first connecter 102 and the second connecter 104 are assembled together, the outer surface of the elastic leg 121 is close to the tops of the snap-fit spring clips 109 to prevent the excessive radial displacement of the sleeve portion 112 relative to the first connecter 102. In this embodiment, the sleeve portion 112 include three elastic legs 121 arranged at intervals circumferentially around the axis i. By providing the elastic legs 121, the sleeve portion 112 also has a certain elasticity, thereby controlling an insertion force and a retaining force between the first connecter 102 and the second connecter 104. It can be understood by those skilled in the art that in other embodiments, it is also possible that the sleeve portion 112 includes no elastic legs, but instead has a complete cylindrical shape. In such embodiments, only the snap-fit spring clips 109 of the first connecter 102 provide elasticity. Thus, the insertion force and the retaining force between the first connecter 102 and the second connecter 104 can be controlled by simply designing the shape of the snap-fit spring clips 109 as needed. The more specific structure of the sleeve portion 112 will be described in detail with reference to FIGS. 2A and 2B.

In this embodiment, the main body portion 111 is substantially in the shape of a cylinder, including a pair of connection beams 113 and a pair of support beams 114 connected between the top and the bottom of the main body portion 111. The pair of connection beams 113 are symmetrically disposed with respect to the axis i, and the pair of support beams 114 are also symmetrically disposed with respect to the axis i. The interior of the main body portion 111 defines a hollow retaining cavity 118. The main body portion 111 further includes a pair of retaining arms 117. Each of the pair of retaining arms 117 extends at one end from an inner surface of a respective one of the pair of connection beams 113 to the retaining cavity 118. In some embodiments, each retaining arm 117 is connected to the respective connection beam 113 via an integrally formed pivot portion 115. Each retaining arm 117 includes thread engaging cogs 119 arranged parallel to the axis i. The thread engaging cogs 119 can engage with a pin 553 having an external thread (see FIGS. 5A and 5B) to retain the pin 553 in the retaining cavity 118 by means of the retaining arms 117. In this embodiment, the pair of retaining arms 117 includes a first retaining arm 117a and a second retaining arm 117b. The two retaining arms 117 are disposed substantially symmetrically in the circumferential direction and their thread engaging cogs 119 are located at different height levels, such that the pair of retaining arms 117 can engage with the external thread of a pin 553 having a greater length along the axial direction. It can be understood by those skilled in the art that the number of retaining arms 117 may be set to be more or less, such that there is a greater or lesser insertion force and retaining force between the main body portion 111 and the pin 553. Moreover, it can be understood by those skilled in the art that in some embodiments, the retaining arms may be configured to have other shapes and structures depending on the different structures of the inserted pin.

The flared mouth portion 123 is substantially in the shape of a bell mouth, which is connected to the bottom of the main body portion 111. The flared mouth portion 123 includes at least one notch 124. The notch 124 can facilitate the flared mouth portion 123 opening and deformation to a certain degree. In this embodiment, the flared mouth portion 123 is provided with two notches 124 symmetrically disposed at the bottom of the flared mouth portion 123. In this way, the flared mouth portion 123 can abut against a body 554 of the second component 552 (see FIG. 5B) to be connected. This provides upward force to the pin 553 of the second component 552, pressing the external thread of the pin 553 against the thread engaging cogs 119 of the retaining arms 117. The flared mouth portion 123 can match and accommodate the greater-diameter head of the pin 553 when the pin 553 is being inserted into the retaining cavity 118. It can be understood by those skilled in the art that the bottom edge of the flared mouth portion 123 may be configured to have a suitable outer contour to match different shapes of the body 554 of the second component 552. It can be understood by those skilled in the art that the flared mouth portion is not essential for the present disclosure. In some embodiments, the second connecter may alternatively include no flared mouth portion. In some embodiments, the second connecter may include the flared mouth portion, but not include the notch.

It should be noted that the present disclosure is not limited to the structure of the main body portion described in this embodiment. The shape and structure of the main body portion can also be configured according to the different shapes and engagement requirements of the second component.

In the present disclosure, the first connecter 102 and the second connecter 104 of the fastening clip 100 may both be made of a plastic material. The first connecter 102 and the second connecter 104 that are made of a plastic material may have a good elasticity to facilitate repeated disassembly and assembly.

FIGS. 2A and 2B are used to more clearly show the internal structure of the fastening clip 100. FIG. 2A is a cross-sectional view of the fastening clip 100 along line A-A, and FIG. 2B is a cross-sectional view of the fastening clip 100 along line B-B. As shown in FIGS. 2A and 2B, the sleeve portion 112 of the second connecter 104 has a hollow sleeve channel 228. In this embodiment, the elastic legs 121 can be elastically deformed to a certain degree into the sleeve channel 228 when the outer surfaces of the elastic legs 121 of the sleeve portion 112 are pressed.

The bottoms of the step portions 122 of the sleeve portion 112 has an inclined bottom end surface 241. The inclined bottom end surfaces 241 are configured to cooperate with the tops of the snap-fit spring clips 109, so as to prevent the downward movement of the second connecter 104 relative to the first connecter 102 when the first connecter 102 and the second connecter 104 are assembled together. In this embodiment, the inclined bottom end surfaces 241 are inclined from bottom to top in a direction gradually away from the axis i. By providing the inclined bottom end surfaces 241 at the bottoms of the step portions 122, when an operator pulls the second connecter 104 out of the first connecter 102, a component force that urges the deformation of the snap-fit spring clips 109 can be generated at the contact positions between the inclined bottom end surfaces 241 of the step portions 122 and the snap-fit spring clips 109, thereby facilitating disassembly of the first connecter 102 from the second connecter 104. The tops of the step portions 122 have a guided surface 242. The guided surfaces 242 are configured to cooperate with the bottoms of the snap-fit spring clips 109. In this embodiment, the guided surfaces 242 are inclined from bottom to top in a direction gradually close to the axis i. By providing the guided surfaces 242 at the tops of the step portions 122, when the operator inserts the second connecter 104 into the first connecter 102, a component force that urges the deformation of the snap-fit spring clips 109 can be generated at the contact positions between the guided surfaces 242 of the step portions 122 and the snap-fit spring clips 109, thereby facilitating assembly of the first connecter 102 and the second connecter 104.

The top of the main body portion 111 of the second connecter 104 has a shoulder 227. The shoulder 227 is formed extending substantially horizontally from a connection portion of the bottom of the sleeve portion 112 and the main body portion 111. When the first connecter 102 and the second connecter 104 are assembled together, the shoulder 227 abuts against a lower surface of the bottom flange 103 of the first connecter 102 to prevent the upward movement of the second connecter 104 relative to the first connecter 102. When the first connecter 102 and the second connecter 104 are assembled together, the step portions 122 and the shoulder 227 together ensure that the first connecter 102 and the second connecter 104 cannot be displaced in the axial direction. Moreover, by disposing the outer diameter of the sleeve portion 112 beneath the step portions 122, the radial and circumferential displacements of the first connecter 102 and the second connecter 104 can be prevented. In this way, the first connecter 102 and the second connecter 104 can keep the snap-fit connected state when they are assembled together.

The pair of connection beams 113 and the pair of support beams 114 of the main body portion 111 are spaced apart from each other in the circumferential direction of the main body portion 111. The connection beams 113 have a greater width (i.e., the dimension in the circumferential direction) but a smaller thickness (i.e., the dimension in the radial direction) than the support beams 114. This is because the connection beams 113 are configured to be provided with the retaining arms 117a and 117b on the inner walls, which requires a space to be reserved in the thickness direction, and because a greater width is required in order to increase the strength of the retaining arms 117a and 117b. The support beams 114 have a greater thickness and a smaller width because the support beams 114 are used to provide strength to the main body portion 111 and a space for machining the retaining arms needs to be reserved.

FIGS. 3A-3D show a more specific structure of the first connecter 102. FIG. 3A shows a perspective view of the first connecter 102, FIG. 3B shows a top view of the first connecter 102, FIG. 3C shows a cross-sectional view of the first connecter 102 along line C-C, and FIG. 3D shows a cross-sectional view of the first connecter 102 along line D-D. As shown in FIGS. 3A-3D, an inner wall of the neck 105 of the first connecter 102 defines the central channel 108. The four snap-fit spring clips 109 are circumferentially disposed at intervals on the inner wall of the neck 105.

In this embodiment, the sleeve portion 112 of the second connecter 104 is inserted into the central channel 108 in the bottom-top direction. The snap-fit spring clips 109 are thus connected at the bottom to the inner wall of the neck 105 and extend from bottom to top obliquely toward the axis i, so that the tops of the snap-fit spring clips 109 form the free ends closest to the axis i. When the snap-fit spring clips 109 are subjected to an outward push force, the snap-fit spring clips 109 deform with pivoting about their bottoms so that the tops of the snap-fit spring clips 109 move away from the axis i, thereby creating an insertion channel and an exit channel for the sleeve portion 112. In this embodiment, the bottom of each snap-fit spring clip 109 has a guide surface 332 extending from bottom to top obliquely toward the axis i. The guide surfaces 332 cooperate with the guided surfaces 242 on the tops of the step portions 122 of the sleeve portion 112 to guide the insertion of the sleeve portion 112 into the central channel 108. Moreover, in this embodiment, the top of each snap-fit spring clip 109 has an inclined top end surface 331 extending from bottom to top obliquely away from the axis i. The inclined top end surfaces 331 are in form-fit with the inclined bottom end surfaces 241 of the step portions 122 of the sleeve portion 112, such that when the second connecter 104 is pulled out of the central channel 108, a component force which pushes the snap-fit spring clips 109 outward can be also generated at the tops of the snap-fit spring clips 109, to deform the snap-fit spring clips 109, thereby enabling the sleeve portion 112 to be pulled out of the central channel 108. In this embodiment, the width of each snap-fit spring clip 109 in the circumferential direction gradually decreases from the top to the bottom, which reduces the force required to deform the snap-fit spring clips 109. In other embodiments, the top ends of the snap-fit spring clips 109 may not be in the shape of an inclined surface, but a component force that urges the deformation of the snap-fit spring clips 109 can also be generated when the second connecter 104 is being pulled out.

In some practical assembly processes, although the first connecter 102 and the second connecter 104 are coaxially arranged, it is not easy to ensure that they are inserted perfectly axially and coaxially during their assembly. The provision of the axially-extending guide strips 107 between the four snap-fit spring clips 109 enables that the guide strips 107 can guide the sleeve portion 112 to be inserted into or pulled out of the central channel 108 even if there is an assembly error between the first connecter 102 and the second connecter 104. Moreover, the guide strips 107 can bear a shear force caused by the misalignment of at least some of the snap-fit spring clips 109 and the corresponding spaces between the elastic legs 121 during the assembly, thereby protecting the snap-fit spring clips 109 from damage.

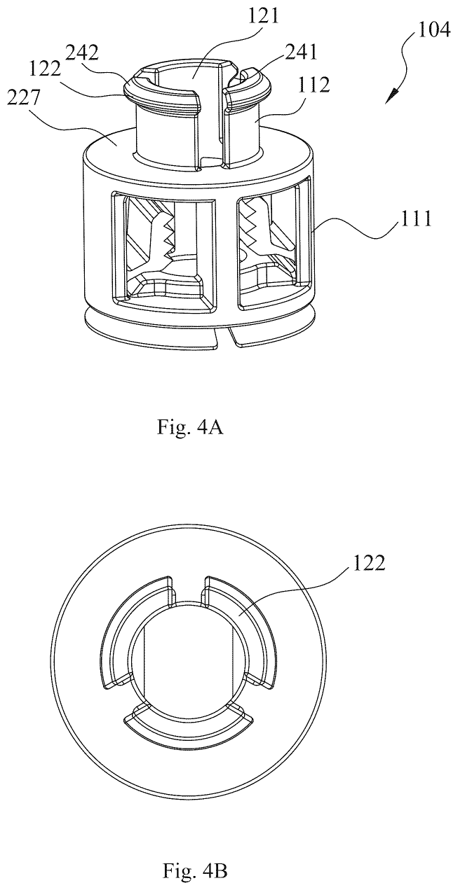

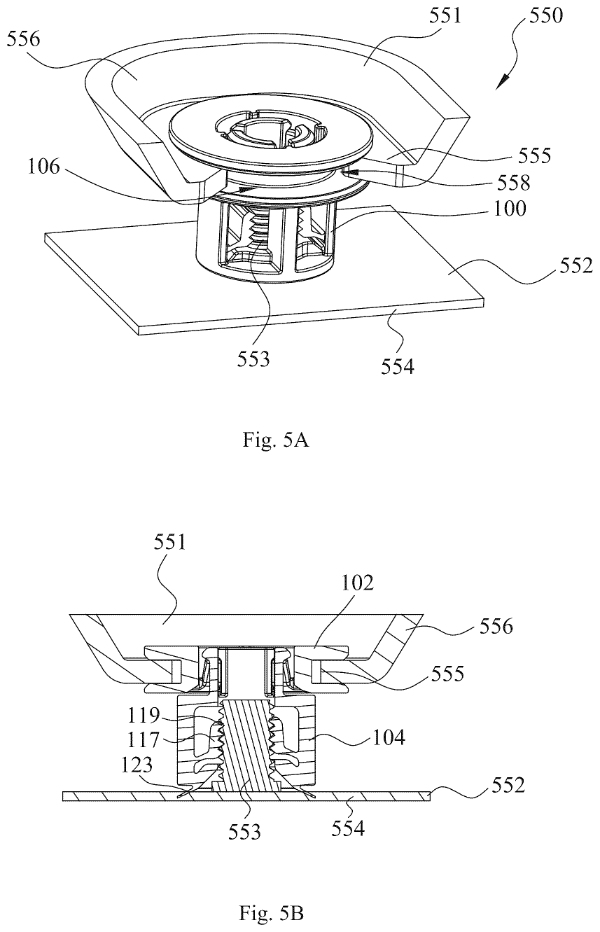

FIGS. 4A and 4B show a more specific structure of the second connecter 104. FIG. 4A is a perspective view of the second connecter 104, and FIG. 4B is a top view of the second connecter 104. As shown in FIGS. 4A and 4B, in this embodiment, the sleeve portion 112 includes three elastic legs 121 arranged at intervals, each elastic leg 121 being respectively provided with a step portion 122 at the top. When the step portions 122 apply a push force to the snap-fit spring clips 109 to push the snap-fit spring clips 109, the elastic legs 121 may also deflect to a certain extent toward the axis i, thereby reducing the force causing the deformation of the snap-fit spring clips 109. In some embodiments, it is also possible that no elastic leg 121 is provided, so that the sleeve portion 112 is inserted into and pulled out of the central channel 108 in its entirety.

Moreover, in the present disclosure, the number of the snap-fit spring clips 109 and the number of the elastic legs 121 are set to be different. This can reduce the difficulty of assembling and disassembling the first connecter 102 and the second connecter 104, so that the operator does not need to align all the snap-fit spring clips 109 with the spaces between the elastic legs 121.

In this way, during insertion of the sleeve portion 112 into the central channel 108 along the axis i of the first connecter 102, the step portions 122 push away the snap-fit spring clips 109, forcing the snap-fit spring clips 109 to be elastically deformed toward the neck 105, to create the insertion channel and the exit channel for the sleeve portion 112. After the sleeve portion 112 is inserted into the central channel 108 of the first connecter 102, the step portions 122 pass over the top end of the snap-fit spring clips 109. This causes that the snap-fit spring clips 109 are no longer pressed by the step portions 122 and return to their original shape. Moreover, the bottoms of the step portions 122 abut against the tops of the snap-fit spring clips 109. The first connecter 102 and the second connecter 104 are thus connected to each other in a snap-fit manner. In a reverse process, the first connecter 102 and the second connecter 104 can be disassembled by pulling the sleeve portion 112 out of the second connecter 104 from the central channel 108 of the first connecter 102 along the axis i.

FIGS. 5A and 5B show the structure of a fastening clip assembly 550 including the fastening clip 100 in an assembled state. FIG. 5A shows a perspective view of the fastening clip assembly 550, and FIG. 5B shows a cross-sectional view of the fastening clip assembly 550 taken along line A-A in FIG. 1C. As shown in FIGS. 5A and 5B, the fastening clip assembly 550 includes a first component 551, a second component 552, and the fastening clip 100. The first component 551 and the first connecter 102 of the fastening clip 100 are connected together. In this embodiment, the first component 551 includes a substantially circular flat plate portion 555 and a ring-shaped wall 556. The flat plate portion 555 is provided with an opening 558 at the front side. The ring-shaped wall 556 is disposed around a peripheral edge of the flat plate portion 555. The flat plate portion 555 is engaged in the groove 106 of the first connecter 102 through the opening 558, and is thus received by the groove 106. The second component 552 and the second connecter 104 of the fastening clip 100 are connected together. In this embodiment, the second component 552 includes a body 554 and a pin 553. The body 554 and the pin 553 are fixedly connected together. The pin 553 can be inserted into the retaining cavity 118 of the second connecter 104 in the bottom top direction, and engages with the retaining arms 117. Moreover, the flared mouth portion 123 abuts against an upper surface of the body 554. In this way, the first component 551 and the second component 552 can be securely connected to each other. As an example, the pin 553 is a weld stud having an external thread that mates with the thread engaging cogs 119 of the retaining arms 117. The pin 553 engages with the thread engaging cogs 119 of the retaining arms 117 by means of the external thread, so that the pin 553 is firmly connected to the second connecter 104.

In the present disclosure, the second component 552 is made of a metal material such as sheet metal of a vehicle. The body 554 is fixedly connected with the pin 553 by welding. The first component 551 is another plastic or metal component of the vehicle. Moreover, the fastening clip 100 is made of a plastic material with a certain elasticity.

It can be understood by those skilled in the art that the shapes of the first component 551 and the second component 552 are shown schematically. In fact, it is sufficient as long as the first component 551 includes the flat plate portion 555 and the second component 552 includes the pin 553.

FIGS. 6A and 6B show the structure of the fastening clip assembly 550 including the fastening clip 100 in a disassembled state. FIG. 6A shows a perspective view of the fastening clip assembly 550, and FIG. 6B shows a cross-sectional view of the fastening clip assembly 550 taken along line A-A in FIG. 1C. As shown in FIGS. 6A and 6B, when the operator pulls the first component 551 upwardly or pulls out the second component 552 downwardly, the fastening clip assembly 550 is changed from the assembled state to the disassembled state. At this moment, the inclined bottom end surfaces 241 of the step portions 122 of the second connecter 104 comes into contact with the inclined top end surfaces 331 of the snap-fit spring clips 109 and a component force that urges the deformation of the snap-fit spring clips 109 is generated, so that the snap-fit spring clips 109 are deformed and the sleeve portion 112 can be pulled out of the central channel 108. Moreover, at this moment, the first connecter 102 and the first component 551 remain connected together and the second connecter 104 and the second component 552 remain connected together, but the first connecter 102 is disassembled from the second connecter 104 so that the first component 551 is disconnected from the second component 552.

By setting the retaining force between the first component 551 and the first connecter 102, the retaining force between the first connecter 102 and the second connecter 104, and the retaining force between the second connecter 104 and the second component 552 within proper ranges, it is possible to make the disassembly of the first connecter 102 and the second connecter 104 easier than the disassembly of the other components, thereby avoiding wear between the fastening clip made of plastic and the first and/or second component made of metal. As a specific example, the retaining force between the first component 551 and the first connecter 102 may be up to 600 N and the retaining force between the second connecter 104 and the second component 552 may be up to 600 N, while the retaining force between the first connecter 102 and the second connecter 104 is only 250 N.

When the operator pushes the first component 551 or the second component 552, the fastening clip assembly 550 can be changed from the disassembled state to the assembled state. At this moment, the guided surfaces 242 of the step portions 122 of the second connecter 104 come into contact with the guide surfaces 332 of the snap-fit spring clips 109 and a component force that urges the deformation of the snap-fit spring clips 109 is generated, so that the snap-fit spring clips 109 are deformed, and the sleeve portion 112 can be inserted into the central channel 108. After the step portions 122 pass over the top ends of the snap-fit spring clips 109, the snap-fit spring clips 109 are no longer subjected to the push force and return to their original shape, and the inclined bottom end surfaces 241 of the step portions 122 abut against the inclined top end surfaces 331 of the snap-fit spring clips 109. The step portions 122 and the shoulder 227 of the second connecter 104 jointly retain the first connecter 102 in position relative to the second connecter 104.

It should be noted that the first connecter 102 and second connecter 104 of the fastening clip 100 are connected together when the fastening clip assembly 550 is assembled for the first time. The fastening clip assembly 550 in an assembled state can be obtained by assembling the first component 551 with the first connecter 102 and assembling the second component 552 with the second connecter 104, respectively. After the first assembly of the fastening clip assembly 550 is completed, the disassembly or assembly of the fastening clip assembly 550 is performed by assembling and disassembling the first connecter 102 and the second connecter 104 of the fastening clip 100.

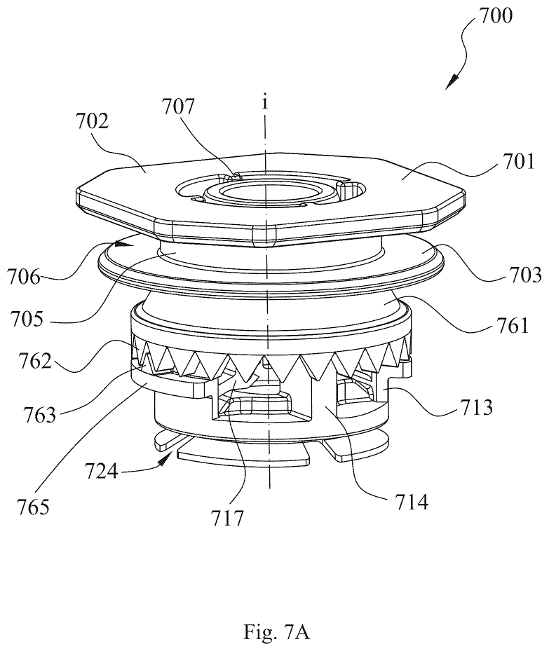

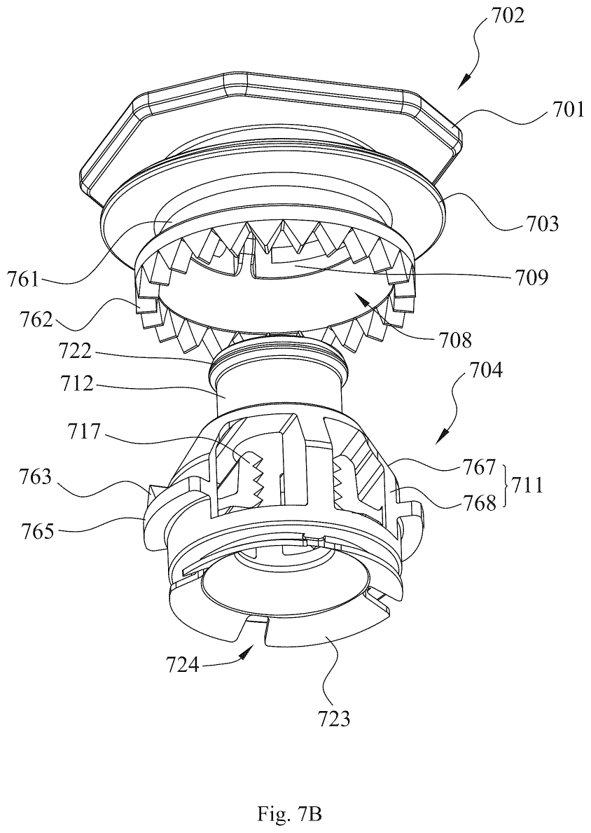

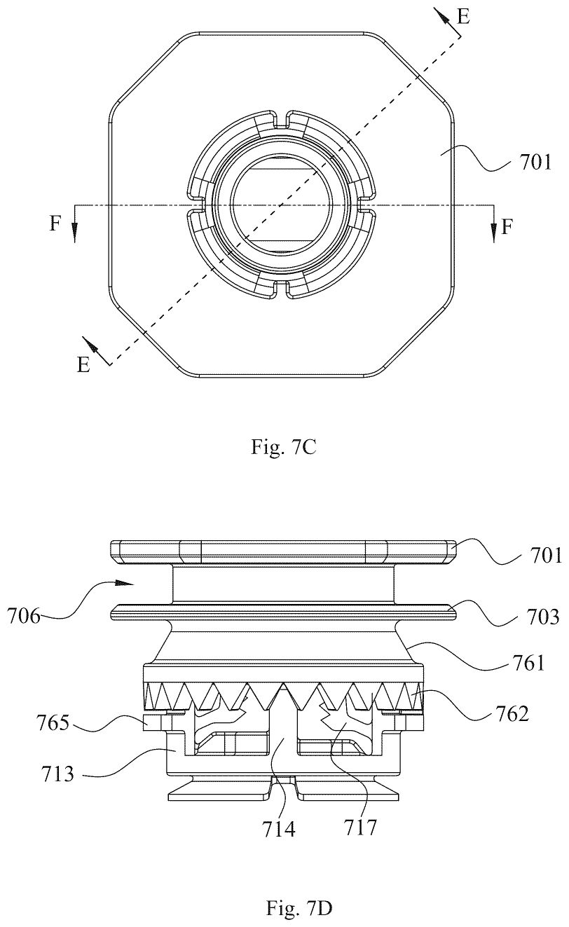

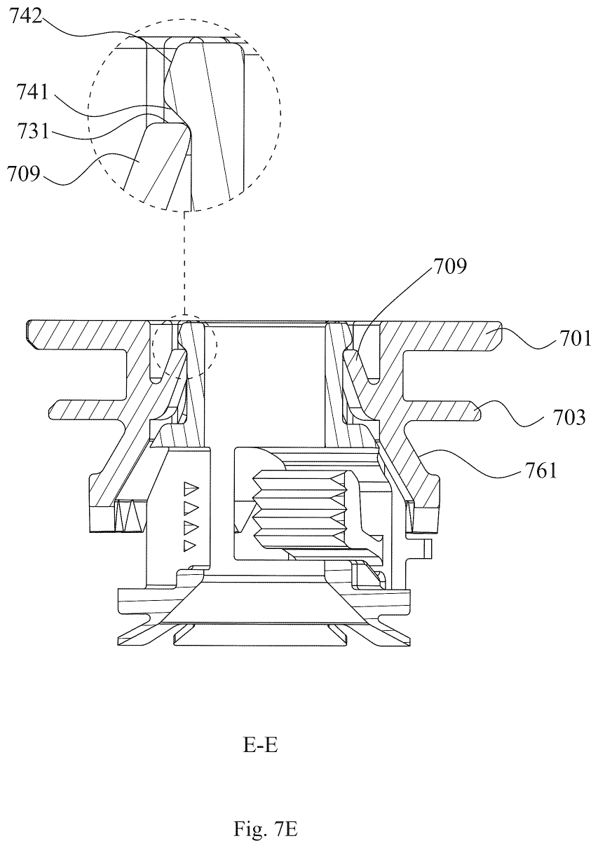

FIGS. 7A-11D show the specific structures of a fastening clip 700 and a fastening clip assembly 1050 according to another embodiment of the present disclosure.

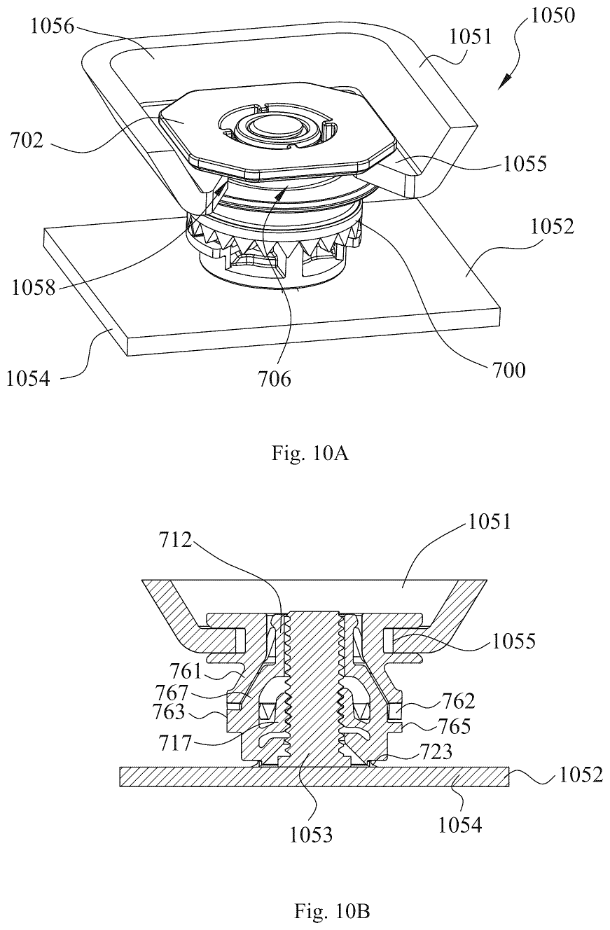

FIGS. 7A-7E show the structure of the fastening clip 700 according to another embodiment of the present disclosure. FIG. 7A shows a perspective view of the fastening clip 700 at one angle, FIG. 7B shows an exploded view of the fastening clip 700 at another angle, FIG. 7C shows a top view of the fastening clip 700, FIG. 7D shows a front view of the fastening clip 700, and FIG. 7E shows a cross-sectional view of the fastening clip 700 along line E-E. As shown in FIGS. 7A-7E, similar to the fastening clip 100, the fastening clip 700 also includes a first connecter 702 and a second connecter 704 that are releasably connected together. The first connecter 702 is configured to connect with a first component 1051 to be securely connected, and a second connecter 704 is configured to connect with a second component 1052 to be securely connected (see FIGS. 10A and 10B).

Similar to the first connecter 102, the first connecter 702 also includes a neck 705, a top flange 701 and a bottom flange 703 with a groove 706 formed between the top flange 701 and the bottom flange 703. A central channel 708 extending along an axis i is defined in the interior of the first connecter 102. Moreover, at least one snap-fit spring clip 709 and at least one guide strip 707 are connected to an inner wall of the central channel 708.

Unlike the first connecter 102, however, the first connecter 702 and the first component 1051 include a first anti-rotation structure to prevent the relative rotation between them. After the first connecter 702 and the second connecter 704 are connected to each other, it is possible to prevent the rotation of the entire fastening clip relative to the first component 1051 since the relative rotation between the first connecter 702 and the first component 1051 are limited. In this embodiment, the first anti-rotation structure includes a top flange 701 and a square ring-shaped wall 1056. The top flange 701 is in the shape of a polygon with edges and corners rather than a circular shape, and the square ring-shaped wall 1056 in the shape of a square ring. After the groove 706 of the first connecter 702 receives a flat plate portion 1055 of the first component 1051, the polygonal top flange 701 can cooperate with the square ring-shaped wall 1056 to prevent the relative rotation between the first connecter 702 and the first component 1051 (see FIG. 10A). It can be understood by those skilled in the art that the first anti-rotation structure may include other anti-rotation structures, and the top flange 701 and the square ring-shaped wall 1056 may be configured to have any matching shapes as long as the relative rotation between the first connecter 702 and the first component 1051 can be prevented.

The first connecter 702 further includes a barrel portion 761. The barrel portion 761 extends axially downwardly and flare outwardly from the bottom of the neck 705, forming a tapered shape. In this embodiment, the size of the opening at the bottom of the barrel portion 761 is greater than the size of the central channel 708. In this connection, the second connecter 704 can be inserted more easily into the central channel 708 with the guidance of the barrel portion 761. Also, the guiding distance during insertion is increased, so that the operator can also connect the first connecter 702 to the second connecter 704 by means of blind insertion in case of a narrow field of view.

Moreover, the first connecter 702 and the second connecter 704 include a second anti-rotation structure for preventing the relative rotation between them. In this embodiment, the second anti-rotation structure includes a first toothed portion 762 disposed on the first connecter 702 and a second toothed portion 763 disposed on the second connecter 704. The first toothed portion 762 and the second toothed portion 763 mesh with each other to prevent the relative rotation between the first connecter 702 and the second connecter 704. In this embodiment, the first toothed portion 762 is disposed at the bottom edge of the barrel portion 761. The second toothed portion 763 is in the shape of a triangular tooth so that even if the second toothed portion 763 of the second connecter 704 is not fully aligned with the first toothed portion 762 of the first connecter 702, the triangular tooth can guide them to rotate relative to each other by a small distance so that the two toothed portions mesh with each other.

Similar to the second connecter 104, the second connecter 704 includes a main body portion 711, a sleeve portion 712, and a flared mouth portion 723. The sleeve portion 712 is connected to the top of the main body portion 711 and has a step portion 722 at the top end. The step portion 722 is configured to cooperate with the snap-fit spring clips 709 of the first connecter 702. The flared mouth portion 723 is connected to the bottom of the main body portion 711 and is provided with at least one notch 724 facilitating the deformation of the flared mouth portion 723. Moreover, the main body portion 711 includes a pair of connection beams 713 and a pair of support beams 714. The main body portion 711 includes a pair of retaining arms 717 in the interior of the main body portion 711. Similarly, in some embodiments, the second connecter 704 may alternatively include no flared mouth portion 723, and the flared mouth portion 723 may alternatively include no notch 724.

In this embodiment, however, the sleeve portion 712 does not include the three elastic legs, but is configured to have a complete cylindrical shape. In this embodiment, the sleeve portion 712 is not elastically deformed, and only the snap-fit spring clips 709 will be deformed. This can avoid such a situation that the sleeve portion 712 cannot be elastically deformed inwardly if the length of the pin 1053 of the second component 1052 is relatively long. In this embodiment, the sleeve portion 712 will not affect the insertion force and the retaining force no matter how long the pin 1053 since only the snap-fit spring clips 709 will be deformed. Moreover, the main body portion 711 is not in the shape of a cylinder, but includes a first main body 767 and a second main body 768 connected to each other. The sleeve portion 712 is connected to the top of the first main body 767, and the flared mouth portion 723 is connected to the bottom of the second main body 768. The first main body 767 matches the shape of the barrel portion 761 of the first connecter 702, and extends downwardly and flares outwardly from the bottom of the sleeve portion 712 to form a tapered shape. Moreover, in this embodiment, a pair of support bosses 765 are provided on the outer sides of a pair of connection beams 713 of the second main body 768. The second toothed portion 763 is arranged on one of the support bosses 765 and is formed protruding upwardly from the top of the support boss 765. In this way, when the first connecter 702 and the second connecter 704 are connected to each other, the barrel portion 761 is sleeved outside the first main body 767, and the first toothed portion 762 of the first connecter 702 can mesh with the second toothed portion 763 of the second connecter 704, so as to prevent the relative rotation between the first connecter 702 and the second connecter 704. As a specific example, the first toothed portion 762 of the first connecter 702 is configured as a ring of teeth arranged in a circumferential direction, while the second toothed portion 763 of the second connecter 704 is configured as one independent tooth. In this way, even if the first connecter 702 and the second connecter 704 have machining tolerance, the first toothed portion 762 and the second toothed portion 763 can mesh and cooperate with each other more easily. Still referring to FIG. 7E, in this embodiment, the step portion 722 of the sleeve portion 712 has an inclined bottom end surface 741 at its bottom end and a guided surface 742 at its top end. The inclined bottom end surface 741 is configured to urge the deformation of the snap-fit spring clips 709 when the second connecter 104 is pulling out of the first connecter 102 in the top-bottom direction. The guided surface 742 is configured to urge the deformation of the snap-fit spring clips 709 when the second connecter 704 is being inserted into the first connecter 702 in the bottom-top direction. Moreover, in this embodiment, the snap-fit spring clips 709 do not include an inclined top end surface that matches the inclined bottom end surface 741, but include a flat top end surface 731 which has a smooth edge. The insertion force required for inserting the second connecter 704 into the first connecter 702 and pull-out force (or retaining force) required for pulling the second connecter 704 out of the first connecter 702 can be adjusted by adjusting the inclination angle and the shape of the top ends of the snap-fit spring clips 109. The applicant has found that, with exerting a certain insertion force and pull-out force, the snap-fit spring clips 709 including the flat top end surface 731 can be repeatedly inserted and pulled out for more times, and the service life of the snap-fit spring clips 709 is longer.

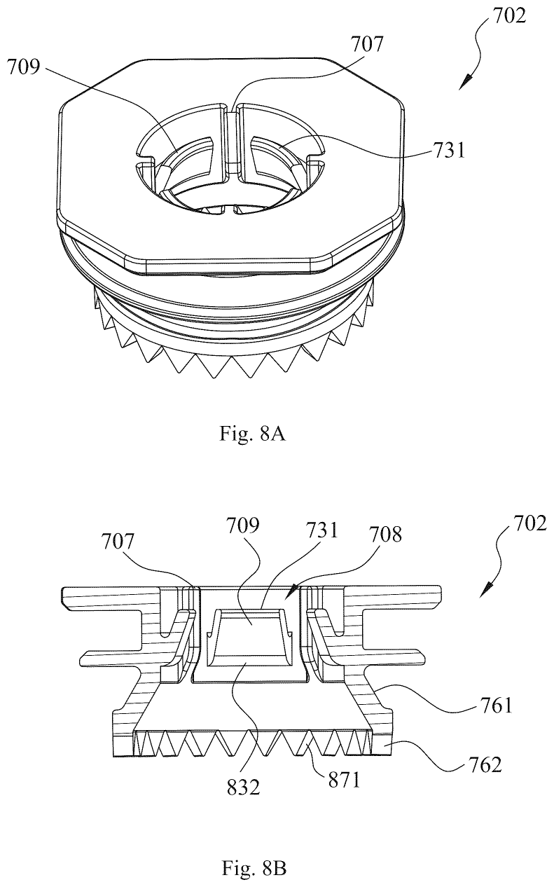

FIGS. 8A and 8B show a more specific structure of the first connecter 702. FIG. 8A shows a perspective view of the first connecter 702, and FIG. 8B shows a cross-sectional view of the first connecter 702 along line E-E of FIG. 7C. As shown in FIGS. 8A and 8B, the first connecter 702 includes four snap-fit spring clips 709 and four guide strips 707. Each guide strip 707 has the same shape as the guide strip 107, and the four guide strips 707 are evenly disposed on the inner wall of the central channel 708. Each snap-fit spring clip 709 is disposed between two adjacent guide strips 707. However, the shape of the snap-fit spring clips 709 is not exactly the same as the shape of the snap-fit spring clips 109.

Specifically, the bottom end of each snap-fit spring clip 709 is connected to the inner wall of the central channel 708. Each snap-fit spring clip 709 extends from the bottom end to the top end (which forms a free end) obliquely toward the axis. Each snap-fit spring clip 709 has a guide surface 832 at the bottom end for cooperating with the step portion 722 of the second connecter 704. Moreover, each snap-fit spring clip 709 has a flat top end surface 731 at the top end. Moreover, in this embodiment, the width of the bottom end of the snap-fit spring clip 709 is greater than the width of the top end. Compared with the snap-fit spring clips 109, the snap-fit spring clips 709 require an increased deformation force due to the greater width at the bottom ends of the snap-fit spring clips 709, but will have a prolonged service life after repeated insertion and pull-out.

Moreover, in this embodiment, the barrel portion 761 of the first connecter 702 and the guide surfaces 832 of the snap-fit spring clips 709 are inclined at substantially the same angle, so as to guide the sleeve portion 712 of the second connecter 704 to be inserted into the central channel 708.

The first toothed portion 762 extends axially downwardly from a bottom end edge of the barrel portion 761 and is a ring of triangular teeth arranged continuously in a circumferential direction. All the teeth have the same shape, and triangular grooves 871 are formed between adjacent teeth for receiving the tooth of the second toothed portion 763. As described above, the triangular teeth facilitate more accurate meshing of the first toothed portion 762 with the second toothed portion 763.

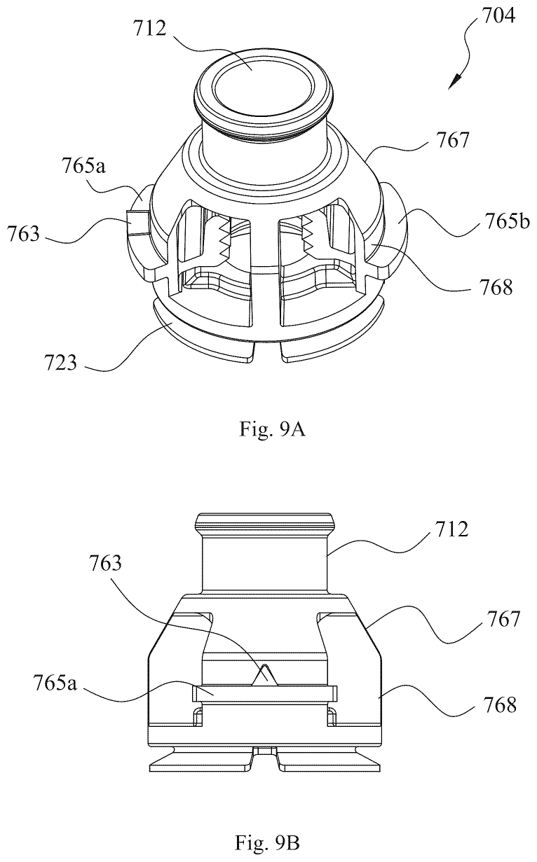

FIGS. 9A and 9B show a more specific structure of the second connecter 704. FIG. 9A shows a perspective view of the second connecter 704, and FIG. 9B shows a left side view of the second connecter 704. As shown in FIGS. 9A and 9B, the second connecter 704 includes a pair of support bosses 765a and 765b. The support bosses 765a and 765b are disposed oppositely on the left and right sides of the main body portion 711 of the second connecter 704, and are formed protruding outwardly from an outer surface of the main body portion 711 on the left and right sides. In this embodiment, the support bosses 765a and 765b are disposed on the right and left sides of the second main body 768 of the main body portion 711. In this way, when the first connecter 702 is connected to the second connecter 704, the first main body 767 of the second connecter 704 is supported on an inner side of the barrel portion 761 of the first connecter 702, and the support bosses 765a and 765b can support the first toothed portion 762 of the first connecter 702.

The second toothed portion 763 is disposed on the support boss 765a. The second toothed portion 763 is formed protruding upwardly from an upper surface of the support boss 765, and is located in the middle of the support boss 765a. The second toothed portion 763 is configured to mesh and cooperate with the first toothed portion 762. In this embodiment, the second toothed portion 763 is also a triangular tooth having a same shape as the grooves formed between adjacent teeth of the first toothed portion 762, so that the second toothed portion 763 can cooperate with the first toothed portion 762.

FIGS. 10A and 10B show the structure of a fastening clip assembly 1050 including the fastening clip 700 in an assembled state. FIG. 10A shows a perspective view of the fastening clip assembly 1050, and FIG. 10B shows a cross-sectional view of the fastening clip assembly 1050 taken along line F-F in FIG. 7C. As shown in FIGS. 10A and 10B, the fastening clip assembly 1050 includes a first component 1051, a second component 1052, and the fastening clip 700. The first component 1051 and the first connecter 702 of the fastening clip 700 are connected together. In this embodiment, the first component 1051 includes a substantially square flat plate portion 1055 and a ring-shaped wall 1056. The flat plate portion 1055 is provided with an opening 1058 on the front side. The ring-shaped wall 1056 is disposed around a peripheral edge of the flat plate portion 1055. The flat plate portion 1055 is engaged in the groove 706 of the first connecter 702 through the opening 1058, and is thus received by the groove 706. In this embodiment, the flat plate portion 1055 has a substantially square shape, and the ring-shaped wall 1056 correspondingly defines a square ring-shaped recess. Moreover, the size of the flat plate portion 1055 is substantially slightly greater than the size of the top flange 701 of the first connecter 702 such that the polygonal top flange 701 can be accommodated within the area surrounded by the ring-shaped wall 1056, but cannot rotate. As a result, the first connecter 702 cannot rotate relative to the first component 1051.

The second component 1052 and the second connecter 704 of the fastening clip 700 are connected together. In this embodiment, the second component 1052 includes a body 1054 and a pin 1053. The body 1054 and the pin 1053 are fixedly connected together. The pin 1053 can be inserted into the second connecter 704 in the bottom-top direction, and engage with the retaining arms 717. Moreover, the flared mouth portion 723 abuts against an upper surface of the body 1054. In this way, the first component 1051 and the second component 1052 can be securely connected to each other. As an example, the pin 1053 is a weld stud having an external thread that mates with the thread engaging cogs of the retaining arms 717, and the pin 1053 engages with the thread engaging cogs of the retaining arms 717 by means of the external thread, so that the pin 1053 is firmly connected to the second connecter 704. In this embodiment, the length of the pin 1053 is substantially the same as the overall height of the second connecter 704, and the middle section of the pin 1053 is configured to engage with the retaining arms 717. The top of the pin 1053 is substantially retained in the sleeve portion 712. It should be noted that an inner wall of the sleeve portion 712 has no teeth for engagement with the external thread of the pin 1053, and the pin 1053 engages with the second connecter 704 only by the retaining arms 717. In this embodiment, the second connecter 704 may be fitted with a pin 1053 having a length extending from the bottom of the retaining arms 717 to the top of the sleeve portion 712.

The barrel portion 761 of the first connecter 702 is sleeved outside the first main body 767 of the second connecter 704, and the first toothed portion 762 of the first connecter 702 abuts against the support bosses 765 of the second connecter 704. Therefore, the second connecter 704 cannot move upwardly relative to the first connecter 702. Moreover, the step portion 722 of the sleeve portion 712 abuts against the top ends of the snap-fit spring clips 709, so that the second connecter 704 cannot move downwardly relative to the first connecter 702 when the second connecter 704 is not subjected to a large pull-out force. In addition, the first toothed portion 762 of the first connecter 702 meshes with the second toothed portion 763 of the second connecter 704, so that the second connecter 704 cannot rotate relative to the first connecter 702. With such a structure, the relatively stable connection between the first connecter 702 and the second connecter 704 can be maintained, such that the fastening clip 700 is formed. Moreover, since the first connecter 702 can be firmly connected to the first component 1051 and the second connecter 704 can be firmly connected to the second component 1052, the fastening clip 700 can firmly connect the first component 1051 and the second component 1052 together.

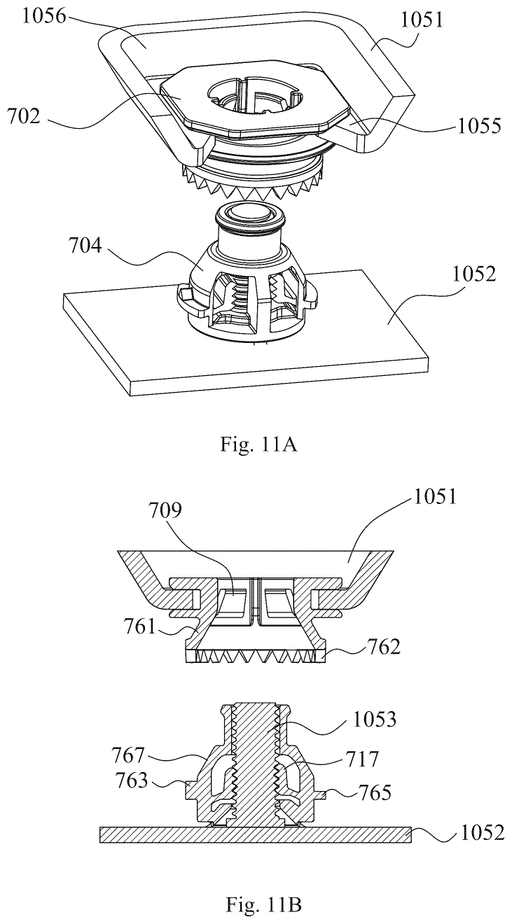

FIGS. 11A and 11B show the structure of the fastening clip assembly 1050 including the fastening clip 700 in a disassembled state. FIG. 11A shows a perspective view of the fastening clip assembly 1150, and FIG. 11B shows a cross-sectional view of the fastening clip assembly 1150 taken along line F-F in FIG. 7C. As shown in FIGS. 11A and 11B, when the operator pulls the first component 1051 upwardly or pulls the second component 1052 downwardly, the fastening clip assembly 1050 can be changed from the assembled state to the disassembled state. At this moment, the inclined bottom end surface 741 of the step portion 722 of the second connecter 704 comes into contact with the flat top end surfaces 731 of the snap-fit spring clips 709 and causes the snap-fit spring clips 709 to be deformed inwardly, so that the sleeve portion 712 can be pulled out of the central channel 708. Moreover, at this moment, the first connecter 702 and the first component 1051 remain connected together, and the second connecter 704 and the second component 1052 remain connected together, but the first connecter 702 is released from the second connecter 704, so that the first component 1051 is release from the second component 1052.

Similar to the fastening clip assembly 550, by setting the retaining force between the first component 1051 and the first connecter 702, the retaining force between the first connecter 702 and the second connecter 704, and the retaining force between the second connecter 704 and the second component 1052 within proper ranges, it is possible to make the disassembly of the first connecter 702 and the second connecter 704 easier than the disassembly of the other components, thereby avoiding the wear between the fastening clip made of plastic and the first and/or second component made of metal.

When the operator pushes the first component 1051 or the second component 1052, the fastening clip assembly 1050 can be changed from the disassembled state to the assembled state. At this moment, the sleeve portion 712 of the second connecter 704 is inserted into the barrel portion 761 of the first connecter 702. After the guided surface 742 of the step portion 722 comes into contact with the guide surface 832 of the snap-fit spring clips 709, and the guided surface 742 urges the deformation of the snap-fit spring clips 709, so that the sleeve portion 712 can be inserted into the central channel 708. After the step portion 722 passes over the top ends of the snap-fit spring clips 709, the snap-fit spring clips 709 are no longer subjected to the push force and returns to its original shape, and the inclined bottom end surface 741 of the step portion 722 abuts against the flat top end surfaces 731 of the snap-fit spring clips 709. The step portion 722 and the support bosses 765 of the second connecter 704 jointly retain the first connecter 102 in position relative to the second connecter 104.

The present disclosure provides a fastening clip including a first connecter and a second connecter which are releasably connected to each other. When the fastening clip connects two components, the first connecter and the second connecter are firmly connected to the two components, respectively. Moreover, the two components are released from each other by release the first connecter and the second connecter of the fastening clip of the present disclosure, so that it is possible to avoid wear between the components made of a metal material and the fastening clip made of a plastic material. The fastening clip of the present disclosure is particularly suitable for connecting two components with at least one being made of a metal material.

In the fastening clip of the present disclosure, the first connecter and the second connecter of the fastening clip have smaller sizes by designing the matching shapes of the sleeve and the snap-fit spring clips while the insertion/pull-out force is still within the required range. The second connecter of the fastening clip of the present disclosure includes the retaining arms which provide a firm connection between the second connecter and the pin having an external thread. This further prevents wear between a metal member and a plastic member when the pin is made of a metal material. Moreover, the fastening clip of the present disclosure is connected to the second component by means of a pin such as a weld stud, thereby eliminating the need for forming a hole in the second component, and thus simplifying the assembly process and reducing the assembly difficulty.

Moreover, in some embodiments of the fastening clip, the first connecter and the second connecter can be better guided to be assembled together by providing the first connecter and the second connecter with the barrel portion and the first main body that match with each other, being particularly suitable for assembly occasions with poor assembly vision.

In addition, in some embodiments of the fastening clip, the relative rotation between the first connecter and the second connecter can be prevented by providing the first connecter and the second connecter with cooperating anti-rotation structures, such as toothed portions meshing with each other. Moreover, in some embodiments, the fastening clip can also prevent the relative rotation between the first connecter and the first component.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

Description of main reference signs:

| | | | |
|---|---|---|---|
| 100 | fastening clip | 700 | fastening clip |
| 101 | top flange | 701 | top flange |
| 102 | first connecter | 702 | first connecter |
| 103 | bottom flange | 703 | bottom flange |
| 104 | second connecter | 704 | second connecter |
| 105 | neck | 705 | neck |
| 106 | groove | 706 | groove |
| 107 | guide strip | 707 | guide strip |
| 108 | central channel | 708 | central channel |
| 109 | snap-fit spring clip | 709 | snap-fit spring clip |
| 111 | main body portion | 711 | main body portion |
| 112 | Sleeve portion | 712 | sleeve portion |
| 113 | connection beam | 713 | connection beam |
| 114 | support beam | 714 | support beam |
| 115 | pivot portion | 717 | retaining arm |
| 117 | retaining arm | 722 | step portion |
| 117a | first retaining arm | 723 | flared mouth portion |
| 117b | second retaining arm | 724 | notch |
| 118 | retaining cavity | 731 | flat top end surface |
| 119 | thread engaging cog | 741 | inclined bottom end |
| | | | surface |
| 121 | elastic leg | 742 | guided surface |
| 122 | step portion | 761 | barrel portion |
| 123 | flared mouth portion | 762 | first toothed portion |
| 124 | notch | 763 | second toothed portion |
| 227 | shoulder | 765 | support boss |
| 228 | sleeve channel | 765a | support boss |
| 241 | inclined bottom end | 765b | support boss |
| | surface | | |
| 242 | guided surface | 767 | first main body |
| 331 | inclined top end surface | 768 | second main body |
| 332 | guide surface | 832 | guide surface |
| 550 | fastening clip assembly | 871 | triangular groove |
| 551 | first component | 1050 | fastening clip assembly |
| 552 | second component | 1051 | first component |
| 554 | body | 1052 | second component |
| 555 | flat plate portion | 1054 | body |
| 556 | ring-shaped wall | 1055 | flat plate portion |
| 553 | pin | 1056 | ring-shaped wall |
| 1053 | pin | 1150 | fastening clip assembly |

What is claimed is:

1. A fastening clip, characterized by comprising:
a first connecter having an axis and a central channel extending along the axis, the first connecter being provided with a groove on an outer peripheral wall; and
a second connecter comprising:
a main body portion provided with a retaining cavity and at least one retaining arm, the at least one retaining arm being connected to an inner surface of the main body portion at one end and extending from the inner surface of the main body portion toward the retaining cavity; and
a sleeve portion connected to the top of the main body portion and receivable in the central channel of the first connecter;
wherein the first connecter and the second connecter are configured to be releasably connected to each other.

2. The fastening clip according to claim 1, wherein the first connecter comprises at least one snap-fit spring clip obliquely extending, from a wall that defines the central channel, toward the central channel, and the sleeve portion of the second connecter is releasably connected to the first connecter via the at least one snap-fit spring clip in a snap-fit manner.

3. The fastening clip according to claim 2,
wherein each of the snap-fit spring clips has a connection end and a free end, one end of each of the snap-fit spring clips being connected to the wall that defines the central channel to form the connection end, and the other end of each of the snap-fit spring clips forming the free end; and
wherein the at least one snap-fit spring clip is configured to be elastically deformable to allow the sleeve portion of the second connecter to enter the central channel and restorable to retain the sleeve portion in the central channel.

4. The fastening clip according to claim 3,
wherein the sleeve portion comprises a step portion formed protruding outwardly from an outer wall of the sleeve portion; and
wherein the sleeve portion is configured such that when the at least one snap-fit spring clip is restored, the step portion abuts against the free end of the at least one snap-fit spring clip to retain the sleeve portion in the central channel.

5. The fastening clip according to claim 4,
wherein the step portion has a guided surface disposed at the top of the step portion and extending obliquely outwardly in the top-bottom direction, the guided surface being configured to cooperate with the at least one snap-fit spring clip so as to urge the at least one snap-fit spring clip to elastically deform to allow the sleeve portion of the second connecter to enter the central channel; and/or
wherein the step portion has an inclined bottom end surface disposed at the bottom of the step portion and extending obliquely inwardly in the top-bottom direction, the inclined bottom end surface being configured to cooperate with the snap-fit spring clip so as to abut against the free end of the snap-fit spring clip upon the snap-fit spring clip restores, to retain the sleeve portion in the central channel.

6. The fastening clip according to claim 4, wherein the step portion has a flat top end surface which has a smooth edge.

7. The fastening clip according to claim 1, wherein the first connecter comprises:
a neck defining the central channel;
a top flange formed extending outwardly from the top of the neck; and
a bottom flange formed extending outwardly from the bottom of the neck;
wherein a ring-shaped groove is defined to form on an outer side of the neck between the top flange and the bottom flange.

8. The fastening clip according to claim 7,
wherein the first connecter further comprises a barrel portion formed extending downwardly and flaring outwardly from the bottom of the neck;
wherein the main body portion of the second connecter comprises a first main body formed extending downwardly and flaring outwardly from the bottom of the sleeve portion; and
wherein the barrel portion and the first main body are matched in shape such that when the first connecter is connected to the second connecter, the first main body abuts against an inner side of the barrel portion.

9. The fastening clip according to claim 8,
wherein the first connecter is configured to be mounted together with a first component; and
wherein a first anti-rotation structure is provided on the first connecter and the first component, the first anti-rotation structure comprising the top flange in the shape of a polygon with edges and corners.

10. The fastening clip according to claim 8, wherein a second anti-rotation structure is provided on the first connecter and the second connecter to prevent the relative rotation between the first connecter and the second connecter.

11. The fastening clip according to claim 10, wherein the second anti-rotation structure comprises a first toothed portion disposed at a bottom end of the barrel portion of the first connecter, and a second toothed portion connected to an outer side of the main body portion of the second connecter, wherein the first toothed portion and the second toothed portion mesh and cooperate with each other to prevent the relative rotation between the first connecter and the second connecter.

12. The fastening clip according to claim 11, wherein the first toothed portion and the second toothed portion are triangular teeth.

13. The fastening clip according to claim 12, wherein the first toothed portion comprises a ring of teeth arranged in a circumferential direction, and the second toothed portion comprises a single tooth.

14. The fastening clip according to claim 13, wherein the second connecter further comprises at least one support boss disposed on the outer side of the main body portion and configured to be capable of at least partially supporting the first toothed portion of the first connecter when the first connecter is connected to the second connecter.

15. The fastening clip according to claim 2, wherein the sleeve portion comprises at least one elastic leg configured to be releasably connected to the at least one snap-fit spring clip in a snap-fit manner.

16. A fastening clip assembly, characterized by comprising:
a first component;
a second component comprising a body and a pin which are fixedly connected to each other; and
a fastening clip according to claim 1;
wherein the first component is received by the groove of the first connecter, and the pin is capable of being cooperatively connected to the at least one retaining arm of the second connecter of the fastening clip to securely connect the first component to the second component.

17. The fastening clip assembly according to claim 16,
wherein the first component comprises a flat plate portion and a ring-shaped wall arranged around a peripheral edge of the flat plate portion, the flat plate portion being engaged within the groove of the first connecter; and
wherein a first anti-rotation structure is provided on the first connecter and the first component, the first anti-rotation structure comprising the top flange in the shape of a polygon with edges and corners and a ring-shaped wall matching the shape of the top flange, to prevent the relative rotation between the first connecter and the first component.

18. The fastening clip assembly according to claim 16, wherein one of the first component and the second component is made of a metal material and the other is made of a plastic material.
